(19) United States
(12) Patent Application Publication
(10) Pub. No.: US 2023/0351667 A1
(43) Pub. Date: Nov. 2, 2023

(54) METHOD AND APPARATUS FOR PERFORMING HIGH SPEED PARALLEL LOCALLY ORDER CLUSTERING FOR A BOUNDING VOLUME HIERARCHY

(71) Applicant: Advanced Micro Devices, Inc., Santa Clara, CA (US)

(72) Inventor: John Alexandre Tsakok, Santa Clara, CA (US)

(73) Assignee: Advanced Micro Devices, Inc., Santa Clara, CA (US)

(21) Appl. No.: 17/957,768

(22) Filed: Sep. 30, 2022

Related U.S. Application Data
(60) Provisional application No. 63/335,284, filed on Apr. 27, 2022.

(51) Int. Cl. G06T 15/00

(52) U.S. Cl. CPC G06T 15/005; G06T 2210/21; G06T 2210/52; G06T 2210/12

(57) ABSTRACT

A technique for building a bounding volume hierarchy is disclosed. The technique includes performing a nearest neighbor search for a set of clusters to generate a set of nearest neighbors; without performing a global barrier operation, performing a merge operation for the set of clusters, based on the set of nearest neighbors to generate merge results for the set of clusters; and without performing a global barrier operation, outputting clusters for a level of the bounding volume hierarchy, based on the merge results.

### CROSS REFERENCE TO RELATED APPLICATIONS

This application claims the benefit of U.S. Provisional Application No. 63/335,284, filed Apr. 27, 2022, the entire contents of which is hereby incorporated by reference as if fully set forth herein.

### BACKGROUND

In image synthesis, ray tracing is utilized to find a nearest intersection of a given ray with a scene where light propagation is simulated.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates merging of clusters from a lower level of the BVH to generate a higher level of the BVH, according to an example;

FIG. 6 illustrates the manipulation of data within a working buffer and an output buffer for performing the parallel locally ordered clustering technique, according to an example;

FIG. 7 illustrates a set of operations for performing an iteration without global barriers between phases of the iteration, according to an example;

FIG. 8 illustrates operations for performing a nearest neighbor search, according to an example;

FIG. 9 illustrates operations for the merge phase, according to an example; and

FIG. 10 illustrates compaction operations, according to an example.

### DETAILED DESCRIPTION

A technique for building a bounding volume hierarchy is disclosed. The technique includes performing a nearest neighbor search for a set of clusters to generate a set of nearest neighbors; without performing a global barrier operation, performing a merge operation for the set of clusters, based on the set of nearest neighbors to generate merge results for the set of clusters; and without performing a global barrier operation, outputting clusters for a level of the bounding volume hierarchy, based on the merge results.

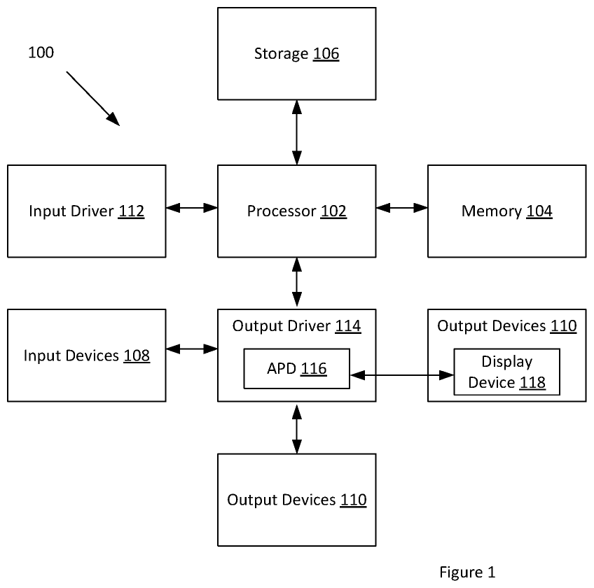

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

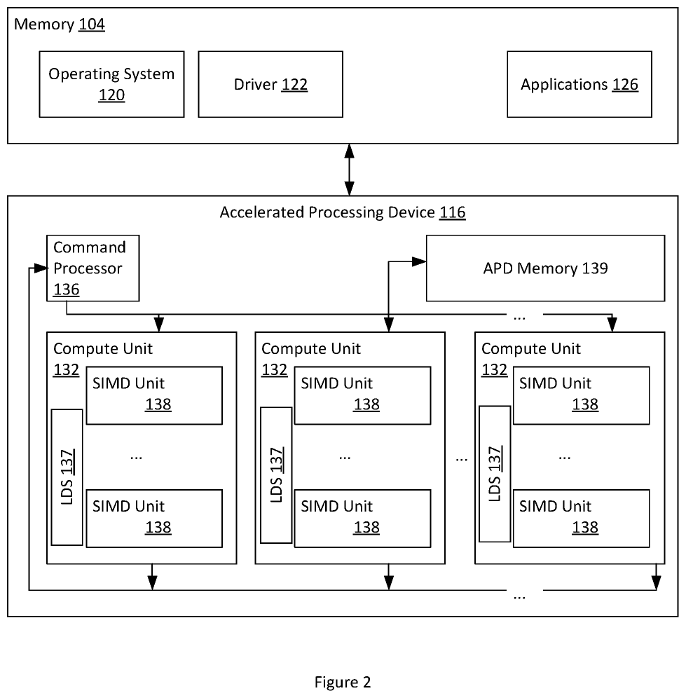

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. The driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The compute units 132 are sometimes referred to as “parallel processing units 202” herein. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

The APD 116 is configured to implement features of the present disclosure by executing a plurality of functions as described in more detail below. For example, the APD 116 is configured to receive images comprising one or more three dimensional (3D) objects, divide images into a plurality of tiles, execute a visibility pass for primitives of an image, divide the image into tiles, execute coarse level tiling for the tiles of the image, divide the tiles into fine tiles and execute fine level tiling of the image. Optionally, the front end geometry processing of a primitive determined to be in a first one of the tiles can be executed concurrently with the visibility pass.

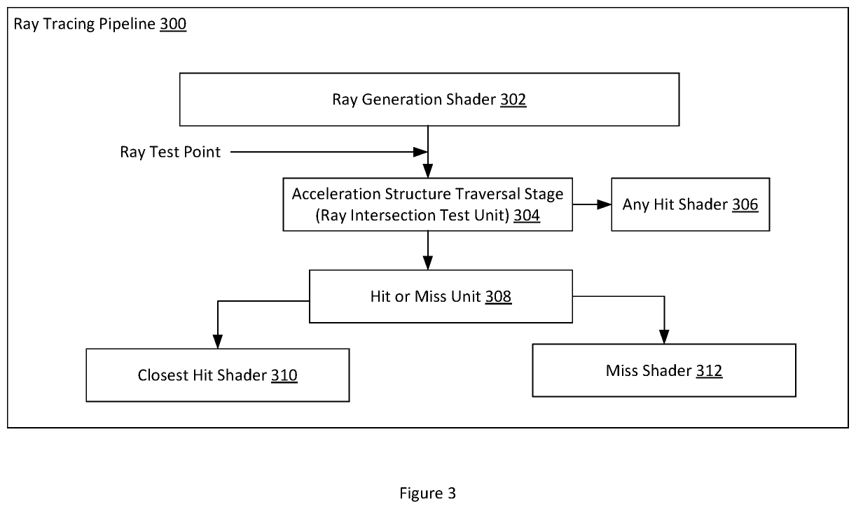

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader. In some examples, rendering a scene involves casting at least one ray for each of a plurality of pixels of an image to obtain colors for each pixel. In some examples, multiple rays are cast for each pixel to obtain multiple colors per pixel for a multi-sample render target. In some such examples, at some later time, the multi-sample render target is compressed through color blending to obtain a single-sample image for display or further processing. While it is possible to obtain multiple samples per pixel by casting multiple rays per pixel, techniques are provided herein for obtaining multiple samples per ray so that multiple samples are obtained per pixel by casting only one ray. It is possible to perform such a task multiple times to obtain additional samples per pixel. More specifically, it is possible to cast multiple rays per pixel and to obtain multiple samples per ray such that the total number of samples obtained per pixel is the number of samples per ray multiplied by the number of rays per pixel.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

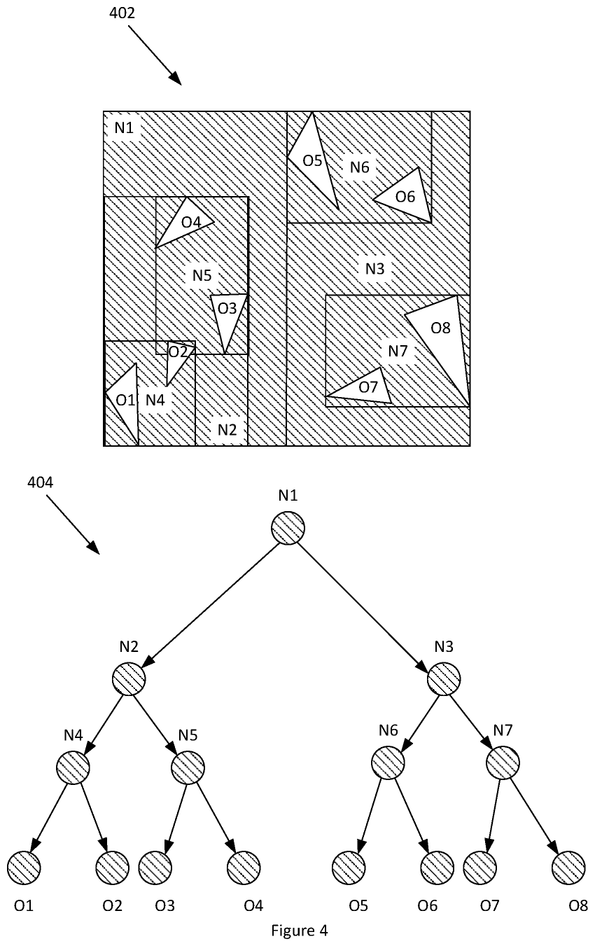

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₂). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails Instead of testing 8 triangle tests, two triangle tests (O₅ and O₆) and five box tests (N₁, N₂, N₃, N₆, and N₇) are performed.

FIGS. 1-4 above describe an implementation in which parallel locally ordered clustering for building a bounding volume hierarchy may be performed. The parallel locally ordered clustering generates a bounding volume hierarchy for a scene, accepting the geometry of the scene (e.g., a collection of triangles) as input and generating a BVH as output. As will be discussed in further detail below, the parallel locally ordered clustering for the bounding volume hierarchy may include performing a search for a nearest neighbor, performing a merge of identified nearest neighbors to generate an output and performing compacting on the output. The parallel locally ordered clustering technique includes several iterations of a neighbor search, merge, and compaction to fully generate a bounding volume hierarchy. Additional detail is now provided.

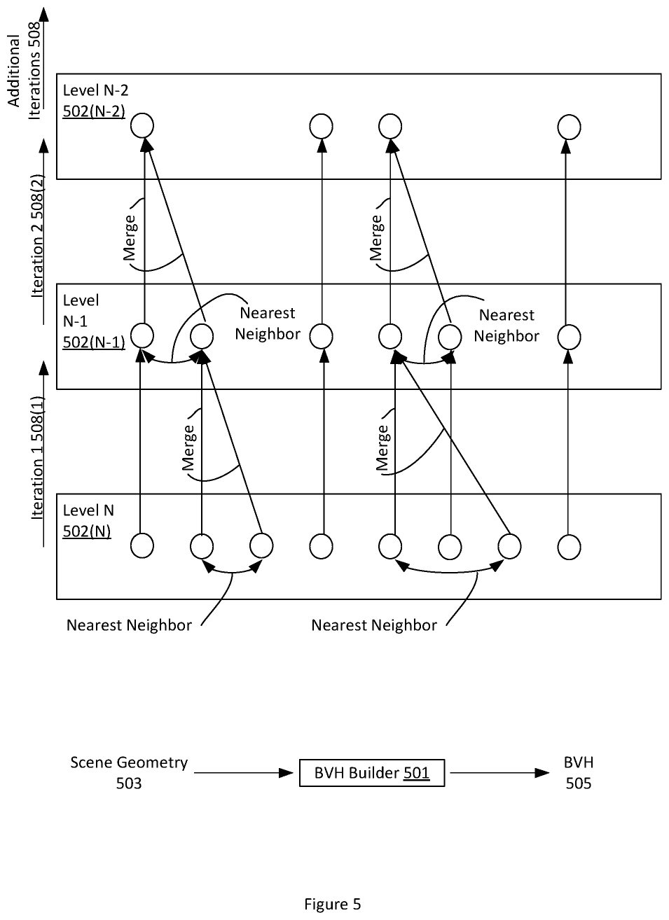

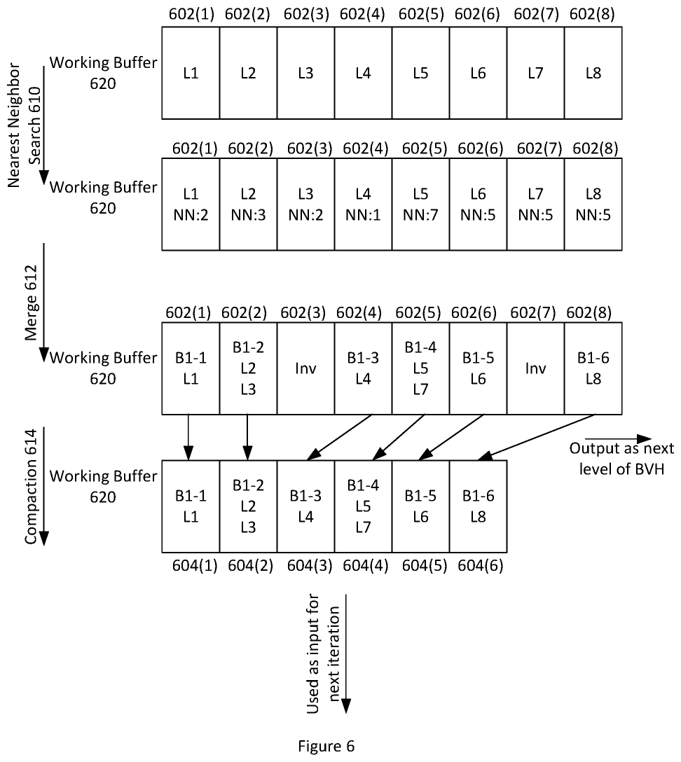

FIGS. 5 and 6 illustrate aspects of a parallel locally ordered clustering technique for building a BVH, according to an example. FIG. 5 illustrates merging of clusters from a lower level of the BVH to generate a higher level of the BVH, according to an example. FIG. 6 illustrates the manipulation of data within a working buffer and an output buffer for performing the parallel locally ordered clustering technique, according to an example. FIGS. 5 and 6 are now described together.

A BVH builder 501 accepts scene geometry 503 and generates a bounding volume hierarchy 505 using a parallel locally ordered clustering technique. The scene geometry 503 includes geometric objects that correspond to the objects of a scene to be rendered. The BVH 505 is a bounding volume hierarchy that allows for quickly determining whether a ray intersects scene geometry of a scene, as described with respect to FIGS. 1-4. In various examples, the BVH builder 501 is embodied completely in software, completely in hardware (e.g., as circuitry), or as a combination thereof. In different examples, the BVH builder 501 is within the device 100 in which ray tracing is performed or is within a different system. In an example, an application developer creates a scene having geometry and uses a BVH builder 501 to generate a BVH corresponding to that scene, then ships the application to a user for execution. In another example, the application developer uses the BVH builder 501 to generate the BVH corresponding to a scene and also executes the application with ray tracing enabled, using the BVH. In another example, a BVH builder 501 present in the device 100 generates a BVH from scene geometry for an application and then the APD 116 uses the generated BVH to render the geometry of the scene. Although some example usage scenarios are described, these examples should not be taken as limiting.

As shown in FIG. 5, the parallel locally ordered clustering technique involves building a BVH in a bottom-up manner. The BVH builder 501 begins with the leaf nodes and proceeds up the hierarchy of the BVH, generating box nodes for higher and higher level 502 until a root node (the top-most node of the BVH) is generated.

The BVH 505 includes multiple levels 502. Starting with level N 502(N), which is the bottom-most level 502, the BVH builder 501 performs a series of iterations 508 to generate each subsequent higher level 502 of the BVH 505. That is, each iteration 508 accepts a level 502 of the BVH 505 as input and generates a next higher level 502 of the BVH 505 as output. Typically, the BVH builder 501 completes this process when the BVH builder 501 has generated a root node.

Each level 502 includes one or more nodes, indicated with circles in FIG. 5. The term “clusters,” used herein, refers to references to these nodes of the BVH. The techniques described herein and performed by the BVH builder 501 generate a BVH including nodes as shown in FIG. 5.

The BVH builder 501 generates a higher level 502 from a lower level 502 in the following manner. The BVH builder 501 performs a nearest neighbor search to find nearest neighbors of the clusters of the lower level 502. The nearest neighbor search can occur in any technically feasible manner. In one example, the nearest neighbor search occurs in the following manner. For each cluster, the BVH builder 501 searches to the left and right of that cluster, within the working buffer 620, for a nearest neighbor of that cluster. This results in an indication, for each cluster, of which other cluster is considered the nearest neighbor of the first cluster.

In some implementations, for any particular cluster, the BVH builder 501 determines which cluster is the nearest neighbor using a combined bounding volume technique. According to this technique, the BVH builder 501 finds the cluster that has the lowest combined bounding volume surface area. A combined bounding volume surface area for two clusters is the surface area of the bounding box that tightly bounds both clusters. Tightly bounding means the smallest bounding box that fully encloses both clusters. There is a combined bounding volume surface area for each combination of two clusters. Thus, for any given cluster, that cluster has a combined volume surface area that corresponds to each of a set of other clusters. The lowest combined volume surface area represents the nearest neighbor. That is, for any given cluster, the cluster having the lowest combined volume surface area is considered the nearest neighbor for that given cluster.

It is possible for two clusters to have nearest neighbors that are not the same. For example, a first cluster has a nearest neighbor that is a second cluster, but the second cluster has a nearest neighbor that is a third cluster. Because the number of possible clusters is very high, the BVH builder 501 limits the search for a nearest neighbor to a “radius.” The “radius” is the range of clusters for which the search is being performed. In other words, the radius simply describes how many clusters to the left and to the right are included in the search. The notion of “left” and “right” is related to a set of clusters processed for a particular level 502 of the BVH. More specifically, each level 502 is associated with a particular set of clusters. Each cluster for a level points to a node in the level 502. The clusters are ordered from left to right. The BVH builder 501 processes this ordered set of clusters to generate the next level 502 of the BVH. In summary, in some implementations, the BVH builder 501 performs the nearest neighbor search for a subject cluster in the following manner. The BVH builder 501 calculates a combined bounding volume surface area for each cluster within the radius of the subject cluster. The BVH builder 501 sets, as the nearest neighbor for the subject cluster, the cluster for which the lowest bounding volume surface area has been determined. The result of performing this search for multiple clusters is that each cluster has an indication of another cluster within a radius that is considered the nearest neighbor.

After finding nearest neighbors, the BVH builder 501 merges nearest neighbor pairs into clusters for the higher level 502. To perform a merge, the BVH builder 501 first determines which clusters are part of a nearest neighbor pair. A first cluster is a part of a nearest neighbor pair with a second cluster if the first cluster has a nearest neighbor that is the second cluster and if the second cluster has a nearest neighbor that is the first cluster. For each nearest neighbor pair, the BVH builder 501 merges those two clusters to form a new node of the higher level 502 of the BVH and to form a new cluster corresponding to that node. This merging results in a single cluster in the higher level 502 where two clusters existed in the lower level 502. The cluster in the higher level 502 points to a node that is a parent of the two nodes that are pointed to by the clusters from which the new cluster was formed.

Examples of such merging are shown in FIG. 5. For example, the second and third node of level N 502(N) are merged into the second node in level N−1 502(N−1). The fifth and seventh nodes of level N 502(B) are also merged into the fourth node of level N−1 502(N−1). Similarly, the first and second nodes of level N−1 502(N−1) are merged into the first node of level N−2 and the fourth and fifth nodes of level N−1 502(N−1) are merged into the third node of level N−2 502(N−2).

After merging, an operation referred to as compaction is then performed. This compaction step is used because, in some implementations, generating the higher level 502 from the lower level 502 is done in-place in a single buffer (the “working buffer 620” of FIG. 6. That is, in such implementations, after writing out the data from the lower level as part of the final BVH, data describing the lower level 502 is stored in a working buffer 620 (FIG. 6). The BVH builder 501 modifies this data in the working buffer 620 in place for the nearest neighbor search and the merging steps. Some of the data item 602 (where each data item 602 is associated with a cluster) become invalid because that data from that data item 602 is merged with another cluster. This invalidation leaves “holes” in the data in the working buffer 620. Thus, the BVH builder 501 compacts the data in the working buffer 620 in order to form the data to be used as input for the next iteration 508, and in order to output data for the newly generated level of the BVH 505. After compaction, the data in the working buffer 620 includes a set of clusters. Any particular cluster can correspond to a node in the output BVH 505. Each cluster in the output level 502 has an indication of the children of that cluster. Thus, the level 502 that is output has a series of clusters, where each cluster points to the children of the clusters in a lower level that were merged to form the cluster in the output.

FIG. 6 illustrates an example of a single iteration, performed in a working buffer 620. The BVH builder 501 performs a nearest neighbor search 610 for each cluster. The nearest neighbor search 610 results in a nearest neighbor (“NN”) assigned for each data item 602. The cluster of data item 602(1) has nearest neighbor 2. The cluster of data item 602(2) has nearest neighbor 3. The data item for cluster 3 has nearest neighbor 2, and so on.

Next, the BVH builder 501 performs a merge 612. It can be seen that the cluster of data item 2 602(2) and the cluster of data item 3 602(3) form a nearest neighbor pair, and the cluster of data item 5 602(5) and the cluster of data item 7 602(7) form a nearest neighbor pair. There are no other nearest neighbor pairs. For example, even though the cluster of data item 1 602(1) indicates that the cluster of data item 2 602(2) is the nearest neighbor, the cluster of data item 2 602(2) does not indicate that the cluster of data item 1 602(1) is a nearest neighbor.

The BVH builder 501 merges the nearest neighbor pairs. This operation includes converting one of the data items 602 in each pair into a merged data item 602 and invalidating the other data item 602 in the pair. In addition, this operation includes generating a new node for the BVH. The new node includes, as children, the nodes pointed to by each cluster in the pair. The BVH builder 501 adds this new node to the BVH. The merged data item 602 includes a cluster that points to this new node. For clusters that are not part of a nearest neighbor pair, those clusters are not merged. The result of the merging operation 612 is as follows: for each nearest neighbor pair in the lower level, the higher level includes one cluster that points to both clusters of the nearest neighbor pair and one invalid cluster; and for each cluster for which there was no nearest neighbor pair, no modification occurs.

Following the merge step, the BVH builder 501 performs a compaction operation 614. The compaction operation compacts the data items 602 of the working buffer 620, with the resulting compacted data items 602 remaining in the working buffer 620. Compacting the data items 602 removes the invalid data items 602. The BVH builder 501 then uses the contents of the working buffer 620 (final data items 604) in that next iteration.

In some implementations, prior to performing the first iteration on the level including leaf nodes, the BVH builder 501 sorts the triangles geometrically. In one example, the sorting is performed based on Morton codes. A Morton code is a transform applied to a set of coordinates that describes a point to generate a scalar, unidimensional number. In some examples, the Morton code is applied to a centroid of the triangles of the leaf nodes, where a centroid is a single point that characterizes a triangle. In some examples, the centroid is the point of intersection of the three medians that bisect each edge and fall on an opposing vertex of the triangle. A Morton code is a characterization of the three-dimensional coordinate values of the centroid. In an example, a Morton code is formed by interleaving at least some of the bits of the three coordinate values. Morton codes allow geometry such as triangles to be easily sorted in a manner that makes “geometric sense.” Sorting the data items 602 of the bottom-most level 502 based on Morton codes helps to ensure that the nearest neighbor search is truly a search for nearby geometry, rather than a search of random geometry. It is better to merge nearby geometry together than geometry that is more distant when building the BVH. Although one technique for sorting the triangles is described, techniques other than sorting based on Morton codes can be used.

In some examples, the BVH builder 501 is at least partly parallelized. In an example, wavefronts are spawned to perform each of the iterations 508. In some examples, each work-item of the wavefront performs work for one data item 602—a subject data item 602. In the nearest neighbor search 610, each work-item determines which cluster is the nearest neighbor to the cluster of the subject data item 602 and writes that information into the subject data item 602. In the merge 612, each work-item determines an updated value for the subject data item 602 based on whether the subject data item is to become a merged data item, an invalid data item, or an unmodified data item 602. A merged data item is a data item that is formed based on a nearest neighbor pair as described above. An invalid data item is a data item that is discarded when a merged data item is formed. An unmodified data item is a data item that is not merged or invalid. Each work-item determines which of the above the data item corresponding to that work-item will become. Then, each work-item performs a corresponding action based on the type of the corresponding data item. For a data item that is merged, the work-item also generates and outputs the corresponding node of the BVH. Because each work-item performs these actions for each data items, the operations for the merge occurs in parallel. Compaction occurs in parallel in a similar manner, with each work-item modifying a corresponding data item as necessary.

The parallel algorithm has data dependencies. More specifically, the nearest neighbor search requires that data from other clusters is available to perform the search. The merge requires data for other clusters to merge (e.g., requires the nearest neighbor information from other clusters). The compaction step requires knowing which clusters are valid or invalid. Thus, in one implementation, one or more wavefronts are launched for each “phase” of each iteration, and a global barrier is used to ensure that all wavefronts have reached the end of the phase before launching wavefronts for a subsequent phase. A global barrier is used at the end of each iteration as well. In an example, wavefronts are launched to perform a nearest neighbor search for a set of clusters corresponding to a very large set of input geometry. A global barrier occurs, preventing further work from being performed until all wavefronts have finished the nearest neighbor search. Then, wavefronts are launched to perform the merging for the clusters. A global barrier occurs, preventing further work from occurring until all wavefronts have finished the merging. Then, wavefronts are launched to perform the compaction for the clusters. A global barrier exists at the end of the compaction, causing all wavefronts to wait until compaction is complete before any wavefront begins the nearest neighbor search for the next iteration. In addition to the above, in a “safe” way of performing BVH build, each thread writes the output of a phase (nearest neighbor search, merge, or compaction) to a general memory such as APD memory or another globally available memory. While this is a “safe” way of performing the above operations, efficiency can be gained by not using global barriers and by allowing operations to proceed at different times in different wavefronts. Care must be taken, however, to respect data dependencies. Techniques are provided herein for performing such operations.

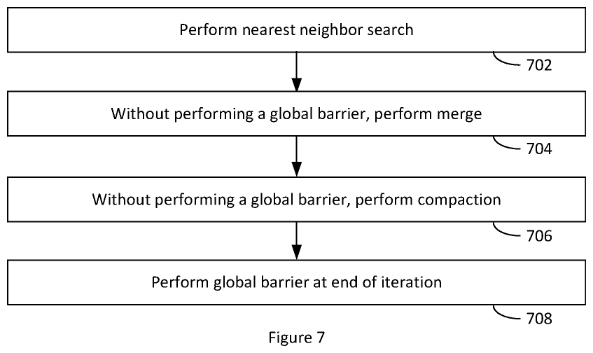

FIG. 7 illustrates a set of operations for performing an iteration 508 without global barriers between phases of the iteration 508, according to an example. The illustrated set of operations are performed by a BVH builder 501. The BVH builder 501 include one or more hardware or software entities. In some examples, the BVH builder 501 is at least partially executed as a number of wavefronts on an APD 116. In some examples, a wavefront that begins executing an iteration continues executing until that iteration is complete. Where it is stated that a BVH builder 501 performs certain actions, this can be interpreted as a wavefront performing these actions.

At step 702, the BVH builder 501 performs a nearest neighbor search. The nearest neighbor search determines, for each subject cluster of a set of clusters, which other cluster is the nearest neighbor of the subject cluster. At step 704, without performing a global barrier, the BVH builder 501 performs a merge. The merge includes merging data items for clusters that are part of a nearest neighbor pair and invalidating data items that have invalid data (due to being part of a nearest neighbor pair but not becoming the resulting merged cluster). Data items having clusters that are not part of a nearest neighbor pair are not merged and not invalidated. At step 706, without performing a global barrier, the BVH builder 501 performs compaction. Compaction includes removing invalid data items. At step 708, the BVH builder 501 performs a global barrier at the end of the iteration. A global barrier is a mechanism by which no wavefronts that are building the BVH as part of the BVH builder 501 can execute past the global barrier until all work for building the BVH and is prior to the global barrier is complete.

The nearest neighbor search, merge, and compaction operations are performed with wavefronts in the following manner. The BVH builder 501 issues a wavefront to process a certain portion of an input to generate an output. The BVH builder 501 issues these wavefronts asynchronously as processing resources become available. In some implementations, the BVH builder 501 issues wavefronts in a particular order, to process the input buffer from beginning to end. For example, the BVH builder 501 issues a first wavefront to process the first N clusters (where N is the number of clusters that can be processed by a wavefront), then the BVH builder 501 issues a second wavefront to process the next N clusters, and so on. Although these wavefronts generally proceed in order, it is possible for later wavefronts to advance ahead of earlier wavefronts (for example, a later issued wavefront can be further along in a particular phase or can be on a subsequent phase as compared with an earlier issued wavefront).

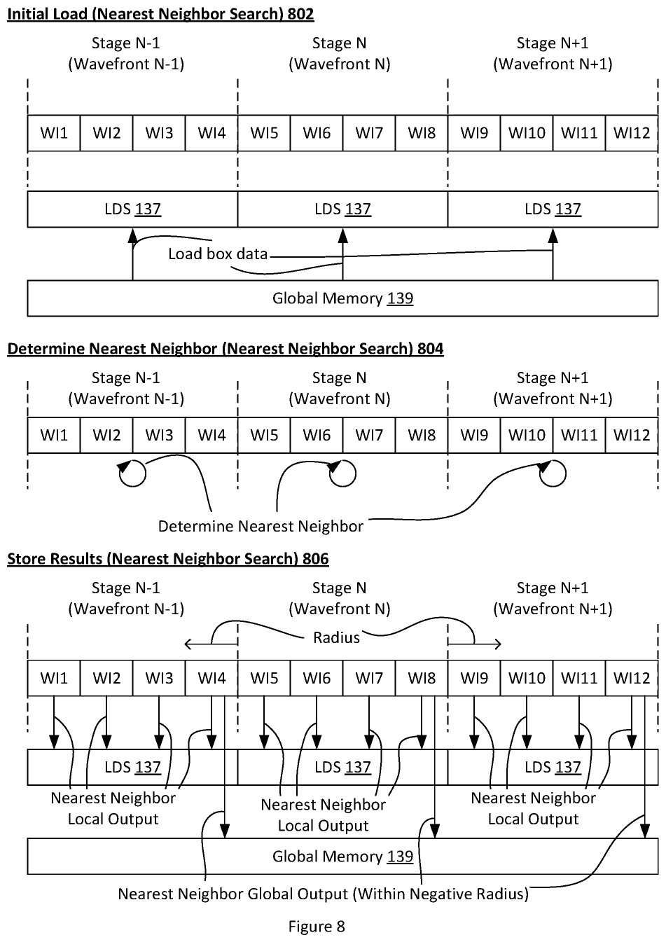

In FIGS. 8, 9, and 10, several different wavefronts are shown. Each wavefront is shown performing operations for a “stage.” A stage is a set of consecutive data (i.e., clusters). Wavefronts processing all stages for a level complete an iteration, generating a new level of a BVH. As described herein, in some implementations, each work-item of a wavefront processes one data item.

FIG. 8 illustrates operations for performing a nearest neighbor search (step 702 of FIG. 7), according to an example. The operations include an initial load 802, a determine nearest neighbor step 804, and a store results step 806. The initial load 802 includes each wavefront loading the data for the clusters processed by the work-items of that wavefront into the local data store 137, as well as the data for the clusters within the radius of the clusters processed by the wavefront. The loaded clusters include the input clusters to the bottom level of the iteration. The loaded data includes geometric data for each such cluster, such as the bounding box for each cluster.

After step 802, the wavefront performs step 804, which includes determining the nearest neighbor for each cluster. For any particular work-item, that work-item performs a search within a radius. The radius is the number of clusters to the left and right in the working buffer 620 for which to determine a nearest neighbor. As described above, in some implementations, a work-item determines the nearest neighbor by determining a combined bounding volume surface area for each cluster in the radius. The work-item selects, as the nearest neighbor for the subject cluster, the cluster for which the combined bounding volume surface area is the lowest.

At the store results step 806 of the nearest neighbor search, each work-item writes out the determined nearest neighbor for the cluster. The work-item writes each such nearest neighbor into the local data store 137. The work-items within the radius of the subsequent stage also write out their nearest neighbors to the global memory 139. Writing this data to the global memory 139 allows work-items of the next stage to perform a nearest neighbor search. If this data were not written to the global memory 139, then a full search could not be performed for work-items within the radius of the last element of stage N. In some examples, work-items not within the radius of the subsequent stage do not write the nearest neighbor to the global memory 139.

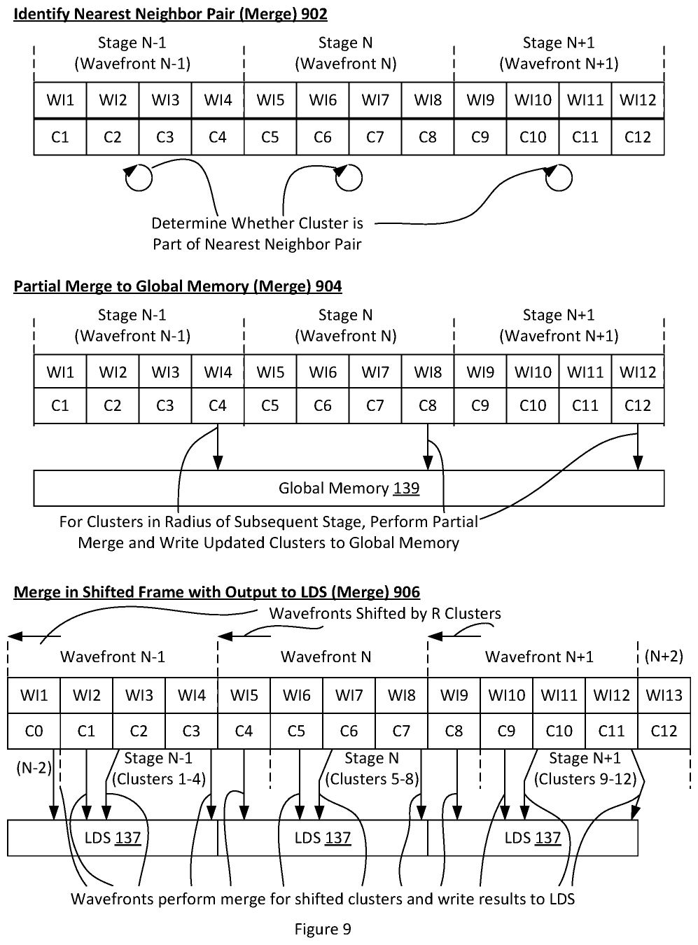

FIG. 9 illustrates operations for the merge phase, according to an example. In the identify nearest neighbor pair operations 902, each work-item determines whether the cluster corresponding to that work-item is part of a nearest neighbor pair. To perform this operation, the work-item determines whether the nearest neighbor of the nearest neighbor of the cluster associated with the work-item is the cluster associated with the work-item. In other words, the work-item already knows the nearest neighbor of the cluster associated with the work item. The work-item examine the data for that nearest neighbor, where the data includes the nearest neighbor for that nearest neighbor. If the nearest neighbor of the nearest neighbor is the cluster associated with the work-item, then the work-item determines that the cluster associated with the work-item is part of a nearest neighbor pair.

There are some complicating factors in perform operation 902. Specifically, sometimes, a nearest neighbor of a cluster for a work-item executing in one wavefront will be a cluster associated with a work-item executing in a different wavefront. For example, it is possible that the nearest neighbor of the cluster for work-item WI5 is the cluster for work-item WI4. In another example, it is possible that the nearest neighbor of the cluster for work-item WI8 is the cluster for work-item WI9. Because it is possible for one wavefront to complete before another wavefront, it is possible for the required data (i.e., nearest neighbor identification) to not be available for a cluster within the radius of another wavefront. For example, if wavefront N reaches the merge phase before wavefront N−1 writes the nearest neighbor data to the global memory 139 (in the nearest neighbor search phase—FIG. 8), then at least one work-item of wavefront N would not be able to perform operation 902 to determine whether the cluster of that work-item is part of a nearest neighbor pair.

To resolve this issue, the BVH builder 501 applies the following rules. For a subject work-item whose nearest neighbor is in a subsequent wavefront, the subject work-item does not perform the nearest neighbor check, and does not perform any steps for merging the cluster associated with the subject work-item. One assumption in this instance is that a subsequent wavefront is not likely to be complete, and thus the data for that subsequent wavefront is not likely to yet be available.

For a subject work-item whose nearest neighbor is in the same wavefront (a “subject wavefront”) or a prior wavefront, that work-items checks the nearest neighbor of the nearest neighbor. It is possible that the prior wavefront has not yet generated a nearest neighbor. In that case, the subject work-item waits until that nearest neighbor is generated. As stated above, however, a work-item whose nearest neighbor is in a subsequent wavefront does not wait for that information to be generated and instead simply does not determine whether a nearest neighbor pair exists. The determination of whether a nearest neighbor exists in this instance is performed by a work-item of the subsequent wavefront.

The notion of wavefronts being “prior to” or “subsequent to” other wavefronts may be defined in one of the following ways. In a first way, a first wavefront is considered prior to a second wavefront if the first wavefront processes clusters that are prior to the clusters processed by the second wavefront in the list of input clusters. In some examples, the list of input clusters is ordered in the manner shown throughout the figures. In a second way, a first wavefront is considered prior to a second wavefront in the event that the first wavefront is issued for execution prior to the second wavefront.

At operation 904, the work-items that are within the radius of the subsequent wavefront perform a partial merge and write the results of the partial merge to global memory 139. A partial merge means performing a merge where all information for the merge is available. If all information for the merge is not available, then no merge is performed. There are three possible outputs from a partial merge: a new cluster that is a merge of two input clusters, an invalid cluster, or a repeat of the input cluster. In the event that all information exists for performing the merge—i.e., that a work-item was able to determine whether the corresponding cluster is part of a nearest neighbor pair, and the cluster is indeed part of a nearest neighbor pair, then the work-item determines whether the cluster associated with that work-item is to be invalid or is to become the merged node. If the cluster is to be merged, then the work-item merges the input nodes to generate a new node pointing to both input nodes and writes the newly generated node to global memory 139. If the cluster is to be invalidated, then the work-item writes an invalid node to the global memory 139. As described elsewhere herein, when a merge occurs, one work-item writes a merged cluster and another work-item writes an invalid cluster. Any technique can be used to determine which work-item of a nearest neighbor pair writes an invalid node and which work-item writes a merged node. In one example, the earlier work-item performs the merge and the later work-item writes an invalid cluster. In the event that all information exists for performing the merge and the cluster is not part of a nearest neighbor pair, then the work-item writes the same node to the global memory 139. In the event that not all information exists for performing the merge, the work-item also write the same node to the global memory 139. As described above, a work-item is able to determine if a nearest neighbor pair exists if the cluster for that work-item has, as its nearest neighbor, a neighbor within the subject wavefront. In this event, the nearest neighbor of that cluster is already known, so a merge can be performed if warranted. As can be seen, a work-item whose nearest neighbor is in the subsequent wavefront does not attempt to perform a merge and outputs the same cluster (the cluster being processed by the wavefront) to the global memory 139.

In operation 906, the wavefront shifts the responsibility of each work-item to the left (i.e., towards earlier clusters, and, e.g., by the radius) and performs the merge for this new set of nodes. The reason for the shift is that the prior wavefront only performed a partial merge for the last few clusters (i.e., clusters within a radius of the current wavefront), and thus the current wavefront must complete that merge. The current wavefront has the information needed to perform the merge for the clusters that were not part of the partial merge for the current wavefront, as well as for clusters of the prior wavefront within the radius of the current wavefront (for those clusters, the current wavefront reads from the global memory 139 to obtain the partial merge results). Thus, the current wavefront shifts responsibility to merge those clusters for which the information exists for the merge. The cluster(s) at the end of the current wavefront, within the radius of the subsequent wavefront, do not have all information, and thus shifting the responsibility of the wavefront also avoids performing the merge operations for those clusters. The wavefront performs the merge (writing a data item for a merged cluster, an invalid cluster, or the same cluster) for these “shifted” clusters and writes the results to the LDS 137, as described elsewhere herein.

For the clusters from the previous wavefront in the shifted frame, the current wavefront performs the following. If the nearest neighbor of that cluster did not point to the current wavefront in the unshifted frame, then sufficient information already existed for that cluster and the wavefront simply writes the old data into the LDS 137. If the nearest neighbor did not have all such information, then the cluster performs the merge operations as described elsewhere herein.

In addition to the above, at step 906, the current wavefront generates the new BVH nodes and writes those nodes to the memory storing the data for the BVH. Each node would be a box node having as children the nodes pointed to by the clusters that were merged and would have a bounding box that bounds all those children.

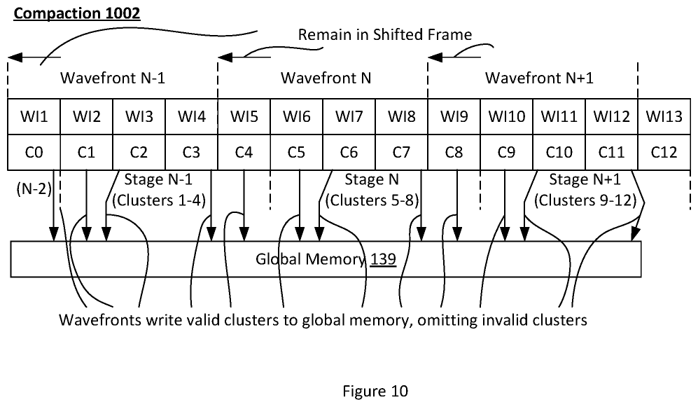

FIG. 10 illustrates compaction operations, according to an example. Compaction 1002 occurs in the shifted frame of FIG. 9. In compaction, each work-item determines whether the corresponding cluster is valid or invalid. If the corresponding cluster is invalid, then the work-item does not output that cluster to the global memory 139 if the corresponding cluster is not invalid, then the work-item outputs that cluster to the appropriate location in the global memory 139. The clusters that are written out are used for subsequent iterations.

In the above description, in some implementations, data not described as being written to the global memory 139 is not written to the global memory 139. Such data may be written to the LDS 137 or in registers.

With the technique described above, an individual wavefront completes all phases (nearest neighbors search, merge, and compaction) for an iteration without performing a global barrier that pauses work between each phase. The wavefront processes an assigned amount of work (clusters) and handles dependencies by outputting a limited set of data to the global memory 139, by reading data output from other wavefronts from the global memory 139 only as needed, and by shifting cluster responsibility as described. A large amount of memory traffic to and from global memory 139 is avoided by writing only the limited set of data described to the global memory 139, and keeping other data in a faster scratch space such as the local data store 137.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the SIMD units 138, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of building a bounding volume hierarchy, the method comprising:
performing a nearest neighbor search for a set of clusters to generate a set of nearest neighbors;
without performing a global barrier operation, performing a merge operation for the set of clusters, based on the set of nearest neighbors to generate merge results for the set of clusters; and
without performing a global barrier operation, outputting clusters for a level of the bounding volume hierarchy, based on the merge results.

2. The method of claim 1, wherein performing the nearest neighbor search includes, for a first cluster of the set of clusters, identifying a second cluster as a nearest neighbor of the first cluster.

3. The method of claim 2, wherein:
the first cluster is with a radius of a stage subsequent to a current stage; and
performing the nearest neighbor search further includes writing the nearest neighbor to a global memory.

4. The method of claim 1, wherein performing the merge operation comprises:
determining that a first cluster of the set of clusters is part of a nearest neighbor pair that includes a second cluster.

5. The method of claim 4, wherein performing the merge operation further comprises:
generating a merged cluster for the first cluster and the second cluster.

6. The method of claim 4, wherein performing the merge operation further comprises:
generating an invalid cluster to replace the first cluster.

7. The method of claim 1, wherein performing the merge operation comprises:
in response to a first cluster having a nearest neighbor within a subsequent wavefront, refraining from performing merge operations for the first cluster.

8. The method of claim 1, wherein performing the merge operation comprises:
merging clusters in a shifted frame.

9. The method of claim 8, further comprising:
repeating the operations of performing the nearest neighbor search, performing the merge operation, and outputting the clusters for each cluster of each level of the bounding volume hierarchy.

10. A system, comprising:
a memory storing instructions; and
a processor configured to execute the instructions, which cause the processor to build a bounding volume hierarchy, by performing operations comprising:
performing a nearest neighbor search for a set of clusters to generate a set of nearest neighbors;
without performing a global barrier operation, performing a merge operation for the set of clusters, based on the set of nearest neighbors to generate merge results for the set of clusters; and
without performing a global barrier operation, outputting clusters for a level of the bounding volume hierarchy, based on the merge results.

11. The system of claim 10, wherein performing the nearest neighbor search includes, for a first cluster of the set of clusters, identifying a second cluster as a nearest neighbor of the first cluster.

12. The system of claim 11, wherein:
the first cluster is with a radius of a stage subsequent to a current stage; and
performing the nearest neighbor search further includes writing the nearest neighbor to a global memory.

13. The system of claim 10, wherein performing the merge operation comprises:
determining that a first cluster of the set of clusters is part of a nearest neighbor pair that includes a second cluster.

14. The system of claim 13, wherein performing the merge operation further comprises:
generating a merged cluster for the first cluster and the second cluster.

15. The system of claim 13, wherein performing the merge operation further comprises:
generating an invalid cluster to replace the first cluster.

16. The system of claim 10, wherein performing the merge operation comprises:
in response to a first cluster having a nearest neighbor within a subsequent wavefront, refraining from performing merge operations for the first cluster.

17. The system of claim 10, wherein performing the merge operation comprises:
merging clusters in a shifted frame.

18. The system of claim 17, wherein the operations further comprise:
repeating the operations of performing the nearest neighbor search, performing the merge operation, and outputting the clusters for each cluster of each level of the bounding volume hierarchy.

19. A non-transitory computer-readable medium storing instructions that, when executed by a processor, cause the processor to build a bounding volume hierarchy, by performing operations comprising:
performing a nearest neighbor search for a set of clusters to generate a set of nearest neighbors;
without performing a global barrier operation, performing a merge operation for the set of clusters, based on the set of nearest neighbors to generate merge results for the set of clusters; and
without performing a global barrier operation, outputting clusters for a level of the bounding volume hierarchy, based on the merge results.

20. The non-transitory computer-readable medium of claim 19, wherein performing the nearest neighbor search includes, for a first cluster of the set of clusters, identifying a second cluster as a nearest neighbor of the first cluster.
